(19) United States
(12) Patent Application Publication
(10) Pub. No.: US 2011/0222573 A1
(43) Pub. Date: Sep. 15, 2011

(54) FIBER LASER HAVING INLINE ISOLATOR FOR PREVENTING DAMAGE TO PUMP LIGHT SOURCE

(76) Inventors: Swook Hann, Gwangju (KR); Young Eun Im, Gwangju (KR); Hanguel Kim, Gwangju (KR)

(21) Appl. No.: 13/130,409

(22) PCT Filed: Mar. 9, 2009
(86) PCT No.: PCT/KR2009/001155

§ 371 Date: May 20, 2011

(30) Foreign Application Priority Data
Nov. 27, 2008 (KR) 10-2008-0118581

(51) Int. Cl. H01S 3/091

(52) U.S. Cl. 372/70

(57) ABSTRACT

Disclosed is a fiber laser to which an isolation technique for preventing damage to a pump light source is applied. The fiber laser, which includes a fiber laser cavity that includes a gain medium, and a pump light source that supplies pump light to the fiber laser cavity, comprises an isolator that is formed in an inline shape between the pump light source and the fiber laser cavity in order to prevent damage to the pump light source which is caused by the ray reflected from the output terminal of the fiber laser.

### TECHNICAL FIELD

The present invention relates to a fiber laser and, more particularly, to a fiber laser to which an isolation technique for preventing damage of a pump light source due to back reflection is applied.

### BACKGROUND ART

Recently, fiber lasers are widely used in various industries and, particularly, high power fiber lasers have attracted attention as substitutes for existing commercial bulk type solid-state lasers.

FIG. 1 is a schematic view of a conventional fiber laser. Referring to FIG. 1, a laser module 10 includes a pump light source 100 and a fiber laser cavity 110. The pump light source 100 generally includes a pump laser diode. Light emitted from the pump light source 100 is input with power of Pᵢₙ to the fiber laser cavity 110 containing a gain medium, and laser beams generated thereby are collected with power of Pₒᵤₜ by a collimator 130 through a delivery fiber 120. However, occasionally, back reflection light which is generated at an output terminal of a laser depending upon light input types of the pump light source 100 may be input with power of P_{back} to the pump light source 100 and damage the same. In the related art, to prevent the pump light source from being damaged due to back reflection light, a pump injector coupler designed such that advancing directions of a pump and back reflection light do not coincide is used, or otherwise a light input method using a V-groove is used. Alternatively, according to a packaging manner of the pump light source, e.g. a pump laser diode, the optical fiber may be processed with an angled patch cord (APC) or antireflection coated when the laser diode and an optical fiber are coupled.

Meanwhile, as an isolator for direct blocking of back reflection light, there are a polarization dependent isolator (which includes an input polarizer, a Faraday rotator, and an output polarizer) using polarization characteristics of a beam, and a polarization independent isolator (which includes an input birefringence wedge, a Faraday rotator, and an output birefringence wedge) using a birefringence crystal, and the like. Further, an optical fiber type expensive isolator and a bulk type optical isolator both using the aforementioned characteristics are currently available.

However, conventional technology has problems in that expensive components such as an isolator are used to prevent damage to the pump light source, or large parts are adopted which inhibits reduction in system volume.

### DISCLOSURE

### Technical Problem

An aspect of the present invention is to provide a fiber laser capable of preventing a pump light source from being damaged without an conventional optical isolator in order to reduce manufacturing costs, and in a manner that a volume thereof is not significantly increased.

Another aspect of the present invention is to provide a fiber laser which is capable of preventing a pump light source from being damaged, facilitates coupling operation by adoption of an optical fiber type, and allows integration of a fiber laser module in a simple manner.

### Technical Solution

In accordance with an aspect of the present invention, a fiber laser, which includes a fiber laser cavity containing a gain medium and a pump light source supplying pump light to the laser cavity, further includes an isolator formed in line between the pump light source and the laser cavity to prevent the pump light source from being damaged by light reflected from an output terminal of the fiber laser.

The isolator may include a plurality of highly reflective fiber Bragg gratings (FBGs), and the respective FBGs may have reflectance of 99% or more with respect to a wavelength of reflected light of the fiber laser.

The pump light source may be a laser diode, and the laser diode may comprise a plurality of distributed devices.

### Advantageous Effects

According to exemplary embodiments of the invention, since the fiber laser adopts an inline isolator (e.g. an inline FBG), the fiber laser can be easily manufactured due to a simple structure and is very advantageous in terms of economical feasibility when a technique for manufacturing the FBG can be supported. Further, in view of price performance, the fiber laser can replace products in the art. That is, the present invention can be applied to any kind of fiber laser in a variety of applications.

### DESCRIPTION OF DRAWINGS

The above and other aspects, features and advantages of the present invention will be more clearly understood from the following detailed description taken in conjunction with the accompanying drawings, in which:

FIG. 1 is a schematic view of a conventional fiber laser;

FIG. 2 is a schematic view of a fiber laser according to an exemplary embodiment of the present invention;

FIG. 3 is a diagram showing simulation results of the fiber laser of FIG. 2 obtained by assigning actual parameters (particularly 99.9% FBG reflectance); and

FIG. 4 is a graphical diagram showing simulation results of the fiber laser of FIG. 2 obtained by assigning actual parameters (particularly 99% FBG reflectance).

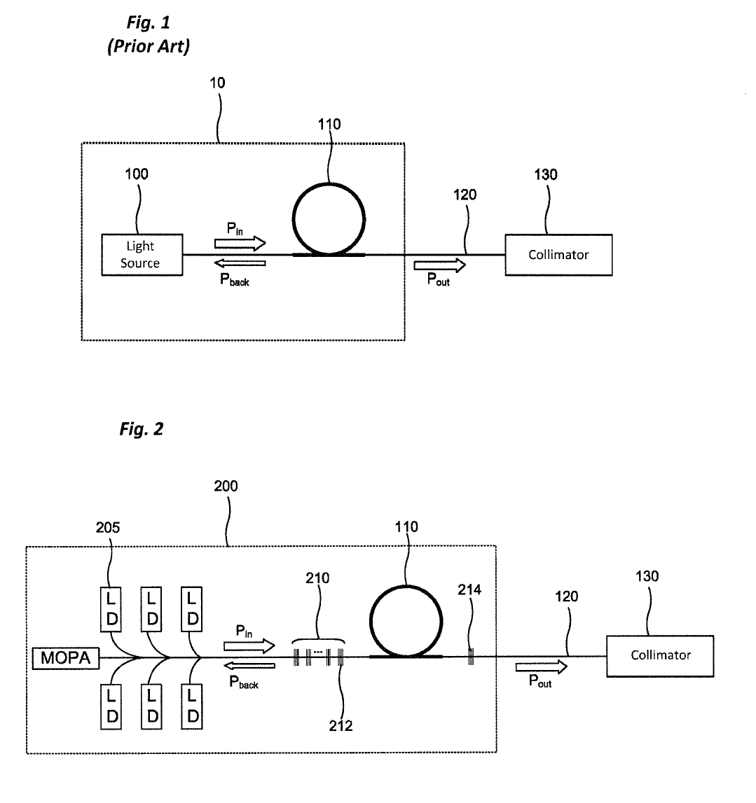

### MODE FOR INVENTION

Next, exemplary embodiments of the invention will be described in detail with reference to the accompanying drawings.

FIG. 2 is a schematic view of a fiber laser according to an exemplary embodiment of the invention. Referring to FIG. 2, in a laser module 200, six pump laser diodes 205 are disposed in a distributed arrangement and serve as a pump light source. A fiber laser cavity 110 forms a resonator between an input reflector 212 and an output reflector 214. The input reflector 212 employs a high reflectivity fiber Bragg grating, and the output reflector 214 employs a low reflectivity fiber Bragg grating. Meanwhile, an inline isolator 210 is configured so that reflectors having the same structure as that of the input reflector 212 are disposed in series between the pump laser diode 205 and the fiber laser cavity 110. In this embodiment, a plurality of highly reflective fiber Bragg gratings (FBGs) each having reflectance of 99.9% or more are used for such an isolator 210. Here, assuming the N FBGs have reflectance of R₁, R₂, . . . , and R_{N}, respectively, transmittance of reflected light from the fiber laser cavity 110 towards the pump laser diode 205 becomes (1−R₁)×(1−R₂)× . . . (1−R_{N}), so that reflected light (P_{back}) of very low power is input to the pump laser diode 205. Such magnitude of power cannot damage the pump laser diode 205. Since such high reflectivity fiber Bragg gratings may be formed on an optical fiber, they may be installed in an inline manner. Thus, the fiber laser of the present embodiment may have a very compact form. MOPA indicated in FIG. 2 denotes a Master Oscillator Power Amplifier.

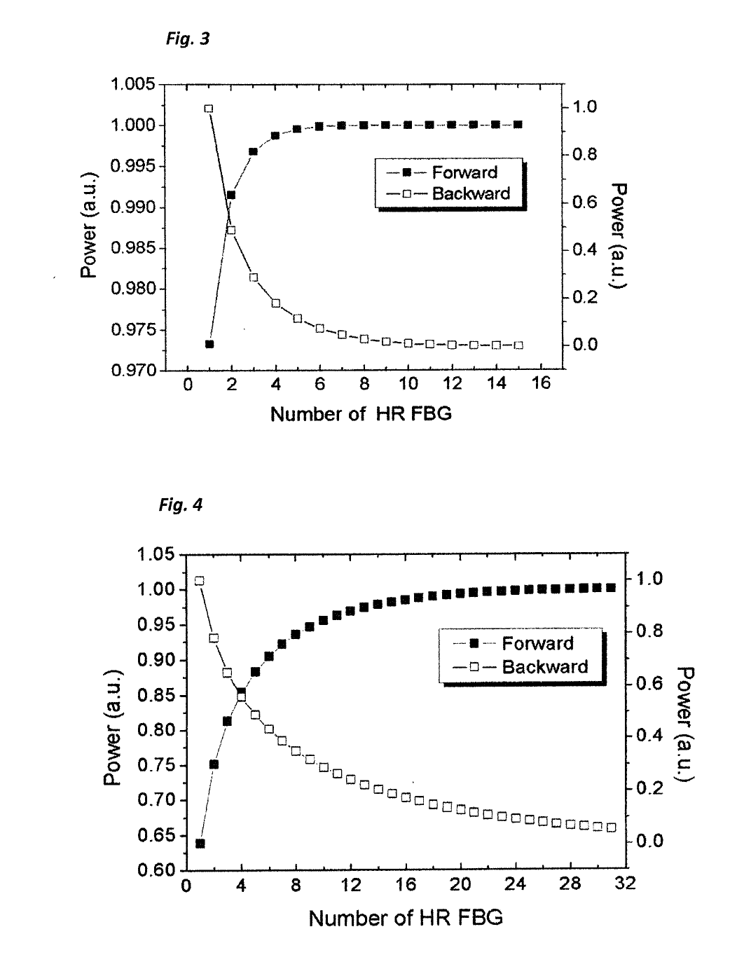

FIG. 3 is a diagram showing simulation results of the fiber laser of FIG. 2 obtained by assigning actual parameters, wherein power (▪) of forward output light and power (□) of back reflection light are shown with respect to the number of high reflectivity FBGs which are included in the isolator 210. For the actual parameters, a Yb-doped optical fiber (length: 10 m, optical loss: about 6 dB at 976 nm) is used as the fiber laser cavity 110, a low reflection FBG (reflectance: 5% (return loss: 13 dB) at 1070 nm) is used as the output reflector 214, and a plurality of high reflection FBGs having reflectance of 99.9% at 1070 nm are used as the isolator 210. Here, the high reflectivity FBG is a Bragg Grating having a 3 dB width of about 1 nm and is similar to a Bragg grating in practice. Referring to FIG. 3, it can be seen that power (□) of back reflection light is inversely proportional to the number of high reflectivity FBGs, sharply converging to 0, whereas power (▪) of forward output light substantially converges to a constant value as the number of high reflectivity FBGs increases to about six or more.

FIG. 4 is a diagram showing simulation results of the fiber laser of FIG. 2 obtained by assigning actual parameters (particularly 99% FBG reflectance). Here, the fiber laser cavity 110 is a Yb-doped optical fiber, the output reflector 214 is a low reflectivity FBG (reflectance: 5% (return loss: 13 dB) at 1070 nm), which is the same as in FIG. 3, and the isolator 210 is a plurality of high reflectivity FBGs having reflectance of 99% (return loss: 20 dB) at 1070 nm. The high reflectivity FBG is also a Bragg Grating having a 3 dB width of about 1 nm. Referring to FIG. 4, it can be seen that power (□) of back reflection light is inversely proportional to the number of high reflectivity FBGs, smoothly converging to 0, whereas power (▪) of forward output light substantially converges to a constant value as the number of high reflectivity FBGs increases to about thirty or more. Comparing with FIG. 3, it can be seen that a slight difference exists. The difference is caused by optical loss between respective devices. However, such loss induces reduction not only in back reflection light, but also in laser output, thereby showing that upon designing a laser cavity, it is necessary to select reflectivity according to manufacturing conditions and characteristics of the FBGs.

As can be seen from the results, the fiber laser of the present invention may have improved efficiency of output power over the conventional fiber laser configured with a single input reflector, and reduce coherent noise in a resonator, thereby stabilizing laser output power. Further, the fiber laser of the present invention employs the same optical fiber type for all devices in a resonator, thereby minimizing coupling loss between the devices while enabling integration of the devices. When high reflectivity FBGs are used, it is possible to previously check power of back reflection light, which may damage the pump laser diode 205, and determine the number of high reflectivity FBGs corresponding to the checked power. That is, determination of the number of high reflectivity FBGs is performed such that power of back reflection light passing through the high reflectivity FBGs is less than power of back reflection light capable of damaging the pump laser diode 205.

Although some embodiments have been described herein, it should be understood by those skilled in the art that these embodiments are given by way of illustration only, and that various modifications, variations, and alterations can be made without departing from the spirit and scope of the invention. For example, while the embodiments have employed the MOPA, it should be understood that the present invention is also applicable to a continuous wave (CW) laser to prevent damage to a pump light source. Therefore, the scope of the present invention should not be construed as being limited only to those embodiments.

1. In a fiber laser comprising a fiber laser cavity containing a gain medium and a pump light source supplying pump light to the laser cavity, the improvement further comprising;
an isolator formed in line between the pump light source and the laser cavity to prevent the pump light source from being damaged by light reflected from an output terminal of the fiber laser.

2. The fiber laser of claim 1, wherein the isolator comprises a plurality of highly reflective fiber Bragg gratings.

3. The fiber laser of claim 2, wherein the respective fiber Bragg gratings have reflectance of 99% or more with respect to a wavelength of reflected light of the fiber laser.

4. The fiber laser of claim 1, wherein the pump light source is a laser diode.

5. The fiber laser of claim 4, wherein the laser diode comprises a plurality of distributed devices.
